(19) United States
(12) Patent Application Publication
(10) Pub. No.: US 2016/0344753 A1
(43) Pub. Date: Nov. 24, 2016

(54) METHOD FOR INSTRUCTION SET MORPHING TO INHIBIT MALICIOUS CODE INJECTION

(71) Applicant: GOVERNMENT OF THE UNITED STATES AS REPRESETNED BY THE SECRETARY OF THE AIR FORCE, Rome, NY (US)

(72) Inventor: RICHARD W. LINDERMAN, ROME, NY (US)

(21) Appl. No.: 14/717,018

(22) Filed: May 20, 2015

(51) Int. Cl. H04L 29/06

(52) U.S. Cl. CPC H04L 63/1416; H04L 63/1466; H04L 63/145; H04L 63/1491

(57) ABSTRACT

A method for improving the reliability and security of computer-based processing by providing instruction set morphing to inhibit malicious software code injection into computer based systems. Method morphs instruction code sets either as the result of a suspected or actual malicious software code attack, or periodically. Encrypting said morphing patterns prevents malicious attackers from acquiring knowledge of morphed software code. Method is amenable to multi-processor systems in a majority voting configuration where any processor producing an inconsistent result is taken offline and its instruction set is remorphed. Memory addresses and conditional branch instructions can also be morphed to cause out-of-bound address attempts or non-execution of instructions, respectively.

### STATEMENT OF GOVERNMENT INTEREST

The invention described herein may be manufactured and used by or for the Government for governmental purposes without the payment of any royalty thereon.

### BACKGROUND OF THE INVENTION

Machine instructions provide the foundation for programmable processors in modern computers. They encode in binary form (often 3 to 64 bits wide) the information of which instruction is to be executed (the opcode) and the fields specifying the operands in one of several ways, commonly by literal value, by memory address pointer, or by reference to a register in the processor. For arithmetic and logical functions, fields within the instruction also indicate which of several functions are to be performed for conditional branching instructions, and fields will indicate which branch condition is to be tested.

Malicious code injections are a primary attack method employed to gain unauthorized access to many cyber systems including desktop computers, cellular phones, laptops, tablets, mainframes, servers and embedded systems. The proliferation of programmable systems creates a tremendous vulnerability exposure to such attacks. However, by altering the format of instructions to pseudo-random variations unknown to the attackers, such attacks can be inhibited and readily detected. McIntosh, in U.S. Pat. No. 7,493,483 B2, taught in 2009 methods to remap a primary field in these instructions, the opcode, which specifies which instruction is to be executed. However, he does not teach the morphing of other fields of the instruction, as presented here.

McIntosh's method also exposes vulnerabilities by remapping opcodes in a “trusted computer base.” The method passes opcodes to the processor over busses that may be subject to snooping, allowing malicious software to view the remapped code. The malicious software can then deduce the new mapping in whole if the original binary code is available or in part using established techniques for instruction set analysis if no reference binary is available.

Triple modular redundancy techniques have been widely employed to improve the resilience of computing systems to unexpected errors. Three processors compute the same function and compare results at some selectable time interval. If a disagreement occurs, the majority vote can be accepted and an investigation then launched on the minority voter. Space-based processors have employed this technique to guard against transient bit upset errors caused by bombardment by high energy particles. This technique is similarly effective to guard against malicious code injections since the paths of execution within the three cores will deviate unless all three are injected in exactly the same way. The power of this technique is further amplified if instruction morphing is employed since an attacker must alter three unknown variations in an exactly consistent fashion. When an attacker attempts to inject code but uses an incorrect assumption about the formatting of the instructions, there are a few possibilities. If the opcode maps to a different instruction, that instruction will execute but perhaps with data arguments and address arguments that are out of range, which causes the processor to immediately trap and investigate. The system designer wants to arrange conditions so that trapping occurs as soon as possible to minimize corruption of machine state, provide a quick indication of a problem to the system, and to help pinpoint the exact location of the malicious code. If the opcode is unmapped (an unused opcode), a trap occurs immediately. If the opcode maps correctly the instruction will execute, but per the present invention, still incorrectly mapped operand fields in the instruction may cause immediate traps or change the results in a way that will be later caught by a triple modular redundancy check.

### OBJECTS AND SUMMARY OF THE INVENTION

It is therefore an object of the present invention to provide a method that improves the reliability and security of computer-based processing by preventing the introduction of malicious software code to enter into a computer-based processing system.

It is a further object of the present invention to prevent the introduction of malicious software code by morphing valid computer instruction sets so as to render the introduction of malicious software code ineffective.

It is still a further object of the present invention to provide a method to prevent the introduction of malicious software code by employing preselected morphing patterns that are indeterminable by any attempts to introduce malicious software code.

It is yet still a further object of the present invention to provide a method to prevent the introduction of malicious software code by morphing valid memory addresses in a manner that causes malicious software code to address invalid memory addresses.

Briefly stated, the present invention achieves these and other objects through a method for instruction set morphing to inhibit malicious software code injection into computer based systems. The present invention morphs instruction code sets either as the result of a suspected or actual malicious software code attack, or periodically. Encrypting the morphing patterns prevents malicious attackers from acquiring knowledge of morphed software code. The present invention is amenable to multi-processor systems in a majority voting configuration where any processor producing an inconsistent result is taken offline and its instruction set is remorphed. Memory addresses and conditional branch instructions can also be morphed to cause out-of-bound address attempts or non-execution of instructions, respectively.

According to an embodiment of the invention, a method for inhibiting the injection of malicious software code in a computer system having processors, memory, and software instruction sets stored therein, and where said software instruction sets further comprise opcode, comprises the steps of generating instruction set morphing patterns; selecting the morphing patterns having the highest probability of trapping malicious software code; morphing the instruction set when suspected of a malicious software code attack; and shutting down any of the processors when suspected of a malicious software code attack; remorphing the instruction set in the shutdown processor; and bringing the shutdown processor back online.

Still according to an embodiment of the invention, the method further comprises loading a new morphing pattern; loading the instruction sets into the processors' memory in encrypted form; protecting that portion of the memory containing the instruction set from external reading; booting the processors; reading the encrypted instruction set; decrypting a segment of the instruction set which is morphed to match the morphing pattern; and executing the decrypted segment of the instruction set.

The above and other objects, features and advantages of the present invention will become apparent from the following description.

### DETAILED DESCRIPTION OF THE PREFERRED EMBODIMENT

The purpose of the present invention is to provide a method by which malicious code injection attacks on computers are rendered ineffective and easily detected. This invention discloses a method to morph all fields of computer instructions, not just opcodes, so as to defeat attempts to inject malicious codes into the machines to achieve a deleterious effect. Morphing instruction formats amongst a large number of possibilities and frequently changing the morphing, presents attackers with a moving target that jumps between what appear to be random configurations. This greatly complicates the task of generating code that will run to achieve a desired effect and greatly increases the likelihood of detection by causing machine traps on bad instructions, bad data, or bad addresses.

To maximize the effectiveness of instruction morphing it is important to keep the morphing method secret from the attackers. It is also important to select morphing patterns likely to lead to quick trapping upon encountering improperly morphed code. It is important to have the option of morphing the instruction set frequently either upon occurrence of an event or at a regular interval. Finally, it is important to detect the intrusion and quickly recover while continuing with a known good result as is offered by triple modular redundancy configuration.

To achieve the first attribute of keeping the morphing pattern secret from attackers, the present invention teaches several steps that should be taken. Unlike the teachings of McIntosh, it is imperative to realize that bus snooping is common tradecraft of hackers. Accordingly, the morphed instructions, and the original unmorphed instructions, should never be exposed unencrypted on any system bus. Given the low area requirements for high speed encryption logic (such as the AES standard), load modules brought into the processor should always be encrypted. The portion of memory used to hold instructions should be protected from external reading.

In the present invention the secure processor booting method employed is to (1) load a new morphing specification as described in more detail below, then (2) boot the processor; (3) read in the encrypted load module; (4) protect the program memory from external access; (5) decrypt the code segment whose instructions are already morphed to match the specification; and (6) jump to executing the code. It is assumed that a multiplicity of load modules are available to the processor to select amongst and store encrypted in memory, potentially external to, but accessible from, the processor. Because of these functions performed by the present invention, the code is never visible to the attackers and thus they are prevented from reverse engineering the morphing specifications.

Another feature of the present invention is the selection of morphing patterns to increase the probability of rapid trapping upon encountering malicious code is achieved with several steps. First, since some users will not choose to morph the instruction set, attackers will with high probability attempt to inject code with the native (unmorphed) instruction set encoding. In the present invention, to promote rapid trapping, the native opcodes of the most commonly used instructions are mapped to invalid opcodes. While particulars for a given architecture may vary, consulting literature on instruction mixes reveals that loading and storing registers from memory and basic ALU instructions constitute a high percentage (typically >50%) of total instructions executed, and when mapped to invalid opcodes the malicious program will quickly become trapped with great disruption of the computer's state which aids pinpointing the infection for rapid analysis. Second, the frequent load and store instructions will address memory and invalid addresses, and will also cause the architecture to trap. Accordingly, the present invention morphs addresses to maximize trapping potential. In particular, the least significant bits will cause unaligned memory traps if not zero in mandatory places, and the most significant address bits will trap if they reach beyond allowable memory regions. By morphing instructions so that “1”s map to the MSBs and LSBs of addresses in the native format, trapping probabilities are increased by the present invention. Third, floating point numbers, when passed as literals, can cause traps with greater probability by introducing Not-A-Numbers or infinites (1's in the exponent field), or denormalized numbers (‘0’ in the exponent field but a ‘1’ somewhere in the mantissa field). In the present invention remapping other fields with strings of 1's or 0's in the native format to these areas will increase the likelihood of data traps in the floating point unit. Fourth, for conditional branch instructions, the present invention provides that the branch condition field in the native instruction set should be mapped to a value that causes an immediate trap if executed.

The present invention will morph the instruction set either periodically or in response to an event (e.g. a perceived increased threat of attack). To achieve this, one method is to shutdown processor execution upon receipt of the signal to remorph (e.g. from a time or external message or discrete signal received) then proceed with the secure boot process described above.

A preferred embodiment of the present invention includes steps that load the morphing specification into the processor by employing an “out-of-band” communication path that does not flow across the potentially snooped system busses. One implementation in the present invention is to use the Joint Test Action Group (JTAG) standard TES interface and define hardware scan paths through select registers of the architecture to load in the new morphing specification. This includes registers holding opcode maps, but also includes registers specifying how all the other fields of the instruction are to be morphed. In the extreme and at the cost of additional decoding logic, each bit of the instruction could be morphed separately, without preserving the concept of continuous multi-bit fields within the instruction.

The present invention will detect intrusions rapidly but also permits continued execution correctly while suspect processors are taken down for examination. To accomplish this, the present invention employs three processors in a triple modular redundancy configuration voting their results to check for consistency at intervals determined by the system software. This check catches side effects of mismatched instruction formats that may have escaped lower level hardware traps described above. A particularly effective strategy is to employ four cores, where three are comparing results at any one time and the fourth is being remorphed to momentarily rejoin the redundant computation, allowing the next processor to be morphed and so on in a continual fashion.

### ADVANTAGES OF THE PRESENT INVENTION

The methods disclosed in the present invention allow for more secure protection of the instruction morphing information by never exposing morphed code in unencrypted form to potentially snooped areas of memory or on system busses. The methods provide greater obfuscation of code beyond simple opcode remapping taught by McIntosh by changing all fields with particular strategies to accelerate trapping upon encountering incorrect malicious code. The present invention discloses new methods to keep the critical morphing specification completely out-of-band so that attackers can only guess the morphing employed. Finally, coupling instruction morphing with multicore architectures and triple modular redundancy techniques further enhances detection of malicious code and recovery from malicious code attacks, while providing resilience to attacks.

### ALTERNATIVES TO THE PRESENT INVENTION

This description of the present invention has been for purposes of illustration and is not intended to a full description of possible alternative embodiments of what is taught, or limited to the present form disclosed. Many variations will be apparent to those reasonably skilled in the art. These include additional strategies to yield rapid trapping, redundancy schemes other than triple modular redundancy, and other out-of-band means of conveying morphing specifications to the processors in a secure fashion. This embodiment was chosen to clearly explain the principles of the invention, its advantages, and the methods by which it can be employed by those reasonably skilled in the art to make various modification to suit particular applications.

Having described preferred embodiments of the invention, it is to be understood that the invention is not limited to those precise embodiments, and that various changes and modifications may be effected therein by one skilled in the art without departing from the scope or spirit of the invention as defined in the appended claims.

What is claimed is:

1. In a computer system having processors, memory, and software instruction sets stored therein, and where said software instruction sets further comprise opcode, a method for inhibiting the injection of malicious software code, comprising the steps of:
generating instruction set morphing patterns;
selecting optimum morphing patterns;
morphing said instruction set according to said selected morphing patterns when a malicious software code attack is suspected; and
shutting down any of said processors when a malicious software code attack is suspected;
remorphing said instruction set in said shutdown processor; and
bringing said shutdown processor back online.

2. The method of claim 1, further comprising the steps of:
loading a new morphing pattern;
loading said instruction sets in to said processors' memory in encrypted form;
protecting that portion of said memory containing said instruction set from external reading;
booting said processors;
reading said encrypted instruction set;
decrypting a segment of said instruction set which is morphed to match said morphing pattern; and
executing said decrypted segment of said instruction set.

3. The method of claim 2, wherein said step of selecting further comprising the step of selecting said morphing patterns which increase the probability of said trapping malicious software code.

4. The method of claim 3, further comprising the step of mapping native opcodes of commonly used instruction sets to invalid opcodes.

5. The method of claim 4, wherein said step of loading further comprises the step of morphing those memory addresses being loaded with said instruction sets, said step of morphing memory addresses further comprises the steps of:
morphing said memory addresses so as to cause a trap when least significant bits of said memory addresses are not zero; and
morphing said memory addresses so as to cause a trap when most significant bits of said memory addresses cause memory addresses to reach beyond allowable memory regions.

6. The method of claim 3, further comprising mapping selected fields of floating point numbers with strings of 1's or 0's so as to cause a trap for said malicious software code.

7. The method of claim 3, further comprising the step of mapping conditional branch instructions within said instructions sets to values which cause an immediate trap for said malicious software code when executed.

8. The method of claim 1 wherein said step of morphing said instruction set further comprised morphing said instruction set periodically.

9. The method of claim 1, further comprising the step of defining hardware scan paths through selected registers of said computer system into which morphing patterns are loaded.

10. The method of claim 1, further comprising the step of employing said processors in a redundant mode of operation, wherein said step of employing redundant operation further comprises the steps of instructing said processors to vote their results so as to catch mismatched instruction sets.
